(19) United States
(12) Patent Application Publication
(10) Pub. No.: US 2025/0210907 A1
(43) Pub. Date: Jun. 26, 2025

(54) ELECTRICAL CONTACT FOR A MALE ELECTRICAL CONNECTOR

(71) Applicant: TE Connectivity Solutions GmbH, Schaffhausen (CH)

(72) Inventors: Jingwen YANG, Pontoise (FR); Xavier ROUILLARD, Pontoise (FR); Sundareshan MALAVALLI DASAPRAKASH, Pontoise (FR); Pierre LEPRIVEY, Pontoise (FR)

(21) Appl. No.: 18/987,391

(22) Filed: Dec. 19, 2024

(30) Foreign Application Priority Data
Dec. 20, 2023 (FR) 2314639

(51) Int. Cl. H01R 13/52

(52) U.S. Cl. CPC H01R 13/521

(57) ABSTRACT

An electrical contact for a male electrical connector includes an electrical contact pin and an O-ring, the pin comprising a first part, a second part, and, between the first part and the second part, a narrowed part adapted to house an O-ring, the O-ring being arranged at the pin, so as to be housed in the narrowed part. An electrical contact pin, a connector housing, and a male electrical connector are provided.

### CROSS REFERENCE TO RELATED APPLICATIONS

This application claims the benefit of FR Application No. 2314639, filed 20-Dec.-2023, the subject matter of which is herein incorporated by reference in its entirety.

### BACKGROUND OF THE INVENTION

The subject matter herein relates to an electrical contact for a male electrical connector. The subject matter herein also relates to an electrical contact pin, a connector housing, and a male electrical connector.

In the field of electrical connectivity, it is known to provide an electrical connector, called a male electrical connector, comprising at least one electrical contact pin, and a homologous electrical connector, called a female electrical connector, comprising at least one homologous electrical terminal, for example an electrical contact terminal. Generally, an electrical contact pin comprises a first part configured to establish an electrical contact and disposed at a first end of the pin, and a second part configured to connect the pin to an electrical conductor and disposed at a second end of the pin. Typically, the first part can have, in a plane orthogonal to the elongation direction of the pin, a rectangular section.

In order to seal the arrangement of an electrical contact pin in a housing of the male electrical connector, certain solutions provide for providing the electrical contact pin with a rectangular seal, the rectangular seal being moulded to have a specific shape homologated to the corresponding rectangular section of the first part. Thus, each type of rectangular section requires a corresponding rectangular seal. Other even more expensive solutions provide for a potting of the pin installed in its male electrical connector housing.

There is a need for an improved solution for sealing a male electrical connector with an electrical contact pin of rectangular cross-section.

### BRIEF DESCRIPTION OF THE INVENTION

In one embodiment, an electrical contact for a male electrical connector is provided including an electrical contact pin and an O-ring. The pin comprises a first part configured to establish an electrical contact with a homologous electrical terminal, the first part being disposed at a first end of the pin and having, in a plane orthogonal to the elongation direction of the pin, a rectangular cross-section. The pin also comprises a second part configured to connect the pin to an electrical conductor, the second part being disposed at a second end of the pin opposite the first end. The pin moreover comprises, between the first part and the second part, a narrowed part adapted to house an O-ring. The O-ring is arranged at the pin, so as to be housed in the narrowed part.

By configuring the electrical contact pin with a narrowed part adapted to house an O-ring, the electrical contact pin can be provided with an O-ring, despite the rectangular section of its first part. Thus, the risks linked to the installation of the O-ring on the rectangular section of the first part, in particular the risk of damage to the O-ring by a ridge of the pin with a rectangular section, and the risk of loss of sealing at the side faces of the pin with a rectangular section, are reduced or even removed.

The subject matter herein offers a sealing solution for a pin with a rectangular section which is less expensive with respect to those known from the prior art, without risking degradation in terms of durability or loss in sealing performance. On the contrary, the subject matter herein can even enable an increase of sealing performance compared to the more expensive solutions of the prior art.

According to an aspect, the narrowed part can have, in a plane orthogonal to the elongation direction of the pin, a rounded section having a shape configured to be fitted by an O-ring. In this configuration, the narrowed part is even better adapted to sealingly house the O-ring.

According to an aspect, the narrowed part can have an oval section or an elliptical section or a section having two parallel sides, which connect between them two arcs arranged at opposite ends of the parallel sides. In particular, the arcs can be two circular arcs, for example, semi-circles. According to another aspect, the narrowed part can have a section having four two-by-two parallel sides, which connect between them four arcs, in particular four quarter-circle arcs, arranged at the intersections of the four two-by-two parallel sides. The O-ring housed in the narrowed part can thus even better fit the shape of the section of the narrowed part and improve the sealing of the housing of the O-ring in the narrowed part.

According to an aspect, the pin can comprise, in a first side of the pin corresponding to a first extension of the rectangular section of the first part, a first indentation, and, in a second side of the pin opposite the first side, a second indentation opposite the first indentation, the first and second indentations together forming the narrowed part. The first extension of the rectangular section can correspond to a thickness of the first part of the electrical contact pin. By forming two opposite indentations, a narrowed part can be obtained, which can house the O-ring more reliably than, for example, with one single indentation. In particular, in this configuration, a movement of the O-ring along the elongation direction of the pin can be blocked.

According to an aspect, the first indentation and/or the second indentation can have a depth of between 100% and 300%, preferably between 150% and 250%, of the first extension of the rectangular section of the first part. With indentations of this depth, the housing of the O-ring can be sufficiently reliable, to not to risk its movement along the elongation direction of the pin, without compromising the structural integrity of the pin and/or the elasticity of the O-ring.

According to an aspect, the first indentation and/or the second indentation can have a depth of between 10% and 40%, preferably between 20% and 30%, of a second extension, preferably orthogonal to the first extension, of the rectangular section of the first part. The second extension of the rectangular section can correspond to a width of the first part of the electrical contact pin. For example, when the electrical contact pin is of the tab type, the first extension, i.e. the thickness, can be less, in particular more than 80% less than a second extension orthogonal to the first extension, i.e. the width. Also, in this configuration, the housing of the O-ring can be more reliable without compromising the integrity of the electrical contact.

According to an aspect, the edges of the first indentation and/or of the second indentation can be rounded, in particular rounded along an oval or elliptical or circular arc. Thus, the risk of weakening of the O-ring can be reduced when it is installed on the pin, in order to be housed in the narrowed part.

The subject matter herein also relates to an electrical contact pin for an electrical contact according to one of the aspects described above. The pin comprises a first part configured to establish an electrical contact with a homologous electrical terminal, the first part being disposed at a first end of the pin and having, in a plane orthogonal to the elongation direction of the pin, a rectangular section, a second part configured for connecting the pin to an electrical conductor, the second part being disposed at a second end of the pin opposite the first end, and, between the first part and the second part, a narrowed part adapted to house an O-ring. This pin can be implemented in an electrical contact according to one of the aspects described above, and thus benefit from the respective advantages of the aspects of the electrical contact.

In an embodiment, a connector housing for a male electrical connector is provided, wherein the housing forms a cavity configured to house an electrical contact according to one of the aspects described above, and having a first face comprising an opening leading to the cavity, the opening having a rectangular section configured to receive the electrical contact pin of the electrical contact. The connector housing comprises a projecting part extending along a perimeter of the opening and having a shape configured to be fitted by an O-ring housed in the narrowed part of the pin, so as to form a sealing seat. Thanks to the projecting part and the sealing seat, the positioning of the O-ring housed in the narrowed part can be additionally secured.

In an embodiment, a male electrical connector is provided including a housing, and an electrical contact according to one of the aspects described above, the pin being housed in the cavity, such that the second part is arranged inside the housing and the first part is arranged outside the housing, and the O-ring being housed in the sealing seat of the housing, so as to fit the shape of the projecting part extending along a perimeter of the opening.

Thus, the installation of the electrical contact pin in the connector housing can be sealed in a quicker and less expensive way, with respect to the solutions of the prior art, without losing sealing performance.

According to an aspect, the male electrical connector can comprise a retaining element enveloping the electrical contact pin and fixed to the projecting part, so as to close the inner space formed by the projecting part. This can further secure and seal the installation of the electrical contact in the connector housing.

According to an aspect, the retaining element can be fixed at an outer surface of the projecting part, in particular by a form-fitting means. This makes it possible to manually lock the electrical contact by means of the retaining element and in particular, to visually verify the locking state.

### BRIEF DESCRIPTION OF THE DRAWINGS

The aims, features and advantages of the invention such as outlined above will be more exhaustively understood and assessed by studying the following, more detailed description of preferred embodiments of the invention, using the accompanying drawings.

FIG. 1 shows an exploded view of a male electrical connector in accordance with an exemplary embodiment.

FIG. 2 shows a perspective view and a close-up view of an electrical contact pin for the connector of FIG. 1.

FIG. 3 shows a cross-sectional view of the electrical connector of FIG. 1 in an assembled state.

FIG. 4 shows a cross-sectional view of part of the electrical connector of FIG. 1 in an assembled state.

### DETAILED DESCRIPTION OF THE INVENTION

The technical features and associated advantages of the embodiments described below can be freely combined one by one, or adapted to particular embodiments, insofar as the spirit of the invention such as described above is respected.

Below, identical references in the figures and the description are used to reference elements of the same nature. Unless otherwise explained in the text, the objects illustrated in the figures are neither to scale with respect to one another, nor to scale in their Cartesian dimensions with respect to one another.

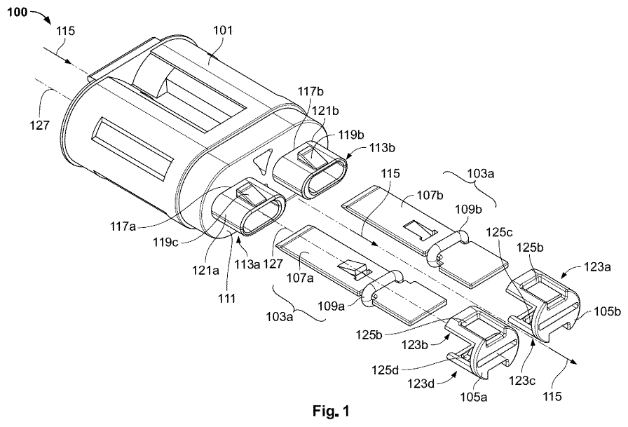

FIG. 1 shows an exploded view of a male electrical connector according to a first embodiment. According to this first embodiment, the electrical connector 100 is a power connector for a vehicle application, in particular in the field of the electric motor vehicles. The electrical connector 100 comprises a connector housing 101, two identical electrical contacts 103a, 103b, and two identical retaining elements 105a, 105b. In this embodiment, the two electrical contacts 103a, 103b are mutually identical, and the two retaining elements 105a, 105b are also mutually identical. Only one single electrical contact 103a, as well as one single retaining element 105a will therefore be described below. Each electrical contact 103a, 103b comprises an electrical contact pin 107a, 107b and an O-ring 109a, 109b.

The connector housing 101, the electrical contacts 103a, 103b and the electrical contact pins 107a, 107b are described below as parts of the electrical connector 100 according to the first embodiment. It must however be noted that the connector housing 101 is also a connector housing for a male electrical connector according to a second embodiment, and each electrical contact 103a, 103b is also an electrical contact for a male electrical connector according to a third embodiment. Likewise, each electrical contact pin 107a, 107b is also an electrical contact pin in according to a fourth embodiment.

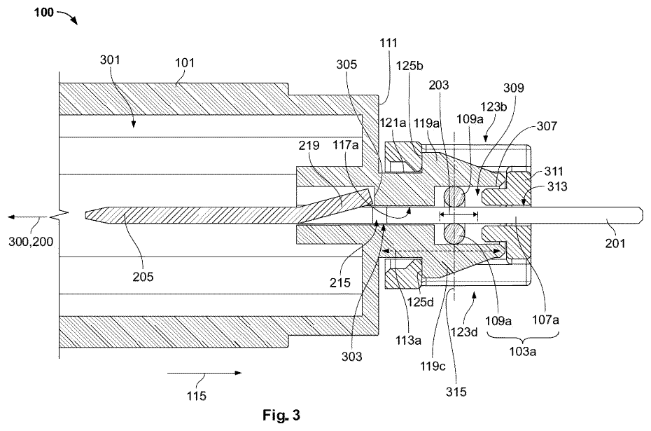

The connector housing 101 is made of elastomer so as to form, for each electrical contact 103a, 103b, a cavity configured to house said respective electrical contact 103a, 103b, such as illustrated, in particular, in FIG. 3. The housing 101 has a first outer face 111 comprising, for each electrical contact 103a, 103b, an opening leading to a respective one of said cavities, such as illustrated in FIG. 3. The housing 101 comprises, for each electrical contact 103a, 103b, a projecting part 113a, 113b projecting from the first face 111 to the outside of the housing 101, in a direction 115 of connection of the connector 100. Each projecting part 113a, 113b extends along a perimeter 117a, 117b of a respective one of said openings, thus forming a closed border around each of the openings.

Each of the projecting parts 113a, 113b comprises a plurality of, in this case two, fixing elements for fixing a retaining element, such as one of the retaining elements 105a, 105b. In this embodiment, the fixing elements are projections 119a, 119b formed on an outer surface 121a, 121b of a respective projecting part 113a, 113b. The projections 119a, 119b are configured as form-fitting means for fixing a retaining element 105a, 105b on the respective projecting part 113a, 113b. In detail, each projection 119a, 119b is configured to elastically deflect a respective leg 123a, 123b, 123c, 123d of a retaining element 105a, 105b during the installation of said retaining element 105a, 105b until a housing of a hook 125a, 125b of the leg 123a, 123b behind the projection 119a, 119b creates a positive engagement. This positive engagement will be described further in reference to FIG. 3.

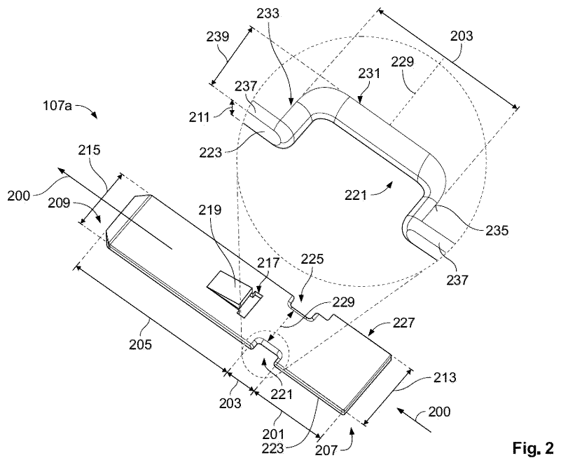

An electrical contact pin 107a for the connector 100 is now described in reference to FIG. 2. The pin 107a is a metal part, preferably of a copper alloy, extending along an elongation direction 200. The pin 107a comprises, in the elongation direction 200, a first part 201, a narrowed part 203, and a second part 205. The narrowed part 203 is arranged, i.e. interposed, between the first part 201 and the second part 203, and adapted to house an O-ring 109a, 109b. The first part 201 is disposed at a first end 207 of the pin 107a and the second part is disposed at a second end 209 of the pin 107a, the second end 209 being opposite the first end 207.

The electrical contact pin 107a is a tab-type pin stamped from a metal sheet, in this case copper alloy. Alternatively, the pin 107a can also be manufactured by milling. The first part 201 of the pin 107a has, in a plane orthogonal to the elongation direction 200, a rectangular section. Said rectangular section has a first extension 211 and a second extension 213 orthogonal to the first extension. The first extension 211 corresponds to the thickness of the pin 107a at the first part 201, and in particular, to the thickness of the metal sheet used. The second extension 213 corresponds to the pin width 107a at the first part 201. In this embodiment, the second extension 213 is at least 6 times, preferably between 7 and 10 times, larger than the first extension corresponding to the thickness 211 of the pin 107a.

In this embodiment, the thickness of the pin 107a is substantially uniform along the elongation direction 200. The width of the pin 107a is not uniform, and in particular, the second extension 213, i.e. the width of the pin 107a at the first part 201, is greater by 3% to 10% than the width of the pin 215 at the second part 205.

The first part 201 is configured to establish an electrical contact with a homologous electrical terminal when the male electrical connector 100 is connected with a homologous female electrical connector. The second part 205 is configured for connecting the pin 107a to an electrical conductor, in particular for crimping or welding with a conductive core of a cable.

The second part 205 moreover comprises a central rectangular perforation 217. A portion of the second part 205 adjacent the central rectangular perforation 217 is partially cut and deflected with respect to the rest of the second part 205 in order to create a locking tab 219 for locking the pin 107a in the housing 101. The locking of the pin 107a by means of the locking tab 219 will be described further in reference to FIG. 3.

A first indentation 221 is formed, between the first part 201 and the second part 205, in a first lateral side 223 of the pin 107a, between the first part 201 and the second part 205. A second indentation 225 is formed opposite the first indentation 221, also between the first part 201 and the second part 205, in a second lateral side 227 of the pin 107a opposite the first lateral side 223. The first and second lateral sides 221, 223 correspond to lateral sides of thickness, i.e. of first extension 211, of the pin 107a. Together, the first indentation 221 and the second indentation 223 form the narrowed part 203. Thus, the narrowed part 203 has a thickness corresponding to the first extension 211 and a width 229 less than the width 213 of the first part 201 and the width 215 of the second part 205.

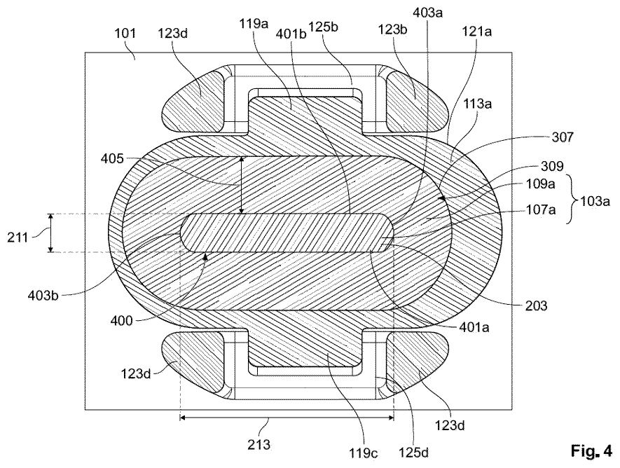

The edges of the indentations 221, 225 are machined so as to round them. Thus, the narrowed part 203 has a section in width 229, i.e. in a plane orthogonal to the elongation direction 200, which is rounded. The shape of the rounded section will be described further in reference to FIG. 4. Figure comprises a close-up view of the pin 107a at the first indentation 221, which illustrates that edges 231 of the indentation 221 extending in a direction parallel to the elongation direction 200 are rounded, and that edges 233, 235 of the indentation 221 extending in a direction orthogonal to the elongation direction 200 are also rounded. Thanks to the rounded edges 231 of the narrowed part 203, an O-ring, such as the seals 109a, 109b, can be housed in the narrowed part 203, so as to fit the shape of the rounded section of the narrowed part 203. I.e. the rounded shape of the section of the narrowed part 203 in width 229 is configured to be fitted by an O-ring 109a, 109b.

In this embodiment, the edges 231, 233, 235 are, in this case, rounded elliptically. In variants, the edges 231, 233, 235 can also be rounded ovally or circularly. The rounding of the edges 231, 233, 235 therefore corresponds to a separate or additional step to an optional chamfering of the ridges of the pin 107a, such as illustrated in FIG. 2 by means of chamfers 237.

In the present embodiment, the indentations 221, 225 have a depth 237, in a direction orthogonal to the elongation direction 200, of between 10% and 40%, preferably between 20% and 30%, of the second extension 213 of the first part 201. Likewise, the depth 237 of the indentations 221, 225 is moreover between 100% and 300%, preferably between 150% and 250%, of the thickness, i.e. of the first extension 211, of the first part 201.

FIG. 3 shows a cross-sectional view of the male electrical connector 100 in an assembled state, along the cross-sectional line 127 indicated in FIG. 1. The electrical contact 103a is installed in the connector housing 101. In detail, the electrical contact pin 107a is housed in a cavity 301 and configured to receive the pin 107a, such that the second part 205 is arranged inside the cavity 301, and the first part 201 is arranged outside the cavity 301 and the housing 101.

For this, the pin 107a is inserted, along an insertion direction 300 parallel to the elongation direction 200 and opposite the connection direction 115, into the cavity 301 through an opening 303 in the first face 111 of the housing 107. In order to be able to accommodate the pin 107a in the insertion direction without losing sealing, the opening 303 has a rectangular section having substantially the dimensions of the second part 205 of the pin 107a, in particular the thickness 211 and the width 215.

By inserting the pin 107a through the opening 303, the locking tab 219 is elastically deflected until it has exceeded the opening 303, then returning to its transverse rest state and thus positively engaging an inner edge 305 of the housing 101.

The projecting part 113a, extending along the perimeter 117a of the opening 303, is formed such that an outer surface 121a of the projecting part 113 comprises the projections 119a, 119c. Moreover, the projecting part 113a is formed such that an inner surface 307 of the projecting part 113a defines an inner open space 309. The space 309 is a sealing seat for the O-ring 109a, such as described below in reference to FIG. 4.

FIG. 3, as well as FIG. 1, shows the electrical contact 103a in an assembled state, in which the electrical contact pin 107a is provided with an O-ring 109a. The O-ring 109a is housed in the narrowed part 203 of the pin 107a. For this, the O-ring 109a is elastically extended and slipped over the first part 201 until said O-ring 109a returns to a more contracted rest state at the indentations 221, 225. In this case, the O-ring 109a is a rubber O-ring, for example of the vinyl-methyl-siloxane (VMQ) type or ethylene-propylene-diene monomer (EPDM) type.

The connector 100, such as illustrated in FIG. 3 in its assembled state, comprises the retaining element 105a, comprises a central part 311, from which the legs 123b, 123d extend. Each leg 123b, 123d comprises a hook 125b, 125d arranged at a respective end of the legs 123b, 123d. The central part 311 comprises a through slot 313 having substantially the dimensions of the rectangular section of the first part 201 of the electrical contact pin 107a, in particular the thickness 211 and the width 213. Thus, the retaining element 105a is configured to be slipped over the first part 201 of the pin 107a, through the through slot 313 going through the central part 311.

When the retaining element 105a is slipped onto the pin 107a, the legs 123b, 123d can be moved closer to the projecting part 113a and elastically deflected over the projections 119a, 119c, in order to create a positive engagement between the projections 119a, 119c and the hooks 125b, 125d, once the projections 119a, 119c have been exceeded. The hooks 125b, 125d and the projections 119a, 119c are complementary elements of a form-fitting means to fix the retaining element 105a at the connector housing 101.

Thus, the retaining element 105a envelops the pin 107a and in particular, the narrowed part 203 of the pin 107, and is fixed to the projecting part 113a. The central part 311 closes, in particular blocks, the open inner space 309 of the sealing seat, thus increasing the sealing of the installation of the electrical contact 103 and securing the contact 103a.

FIG. 4 shows a cross-sectional view of the male electrical connector 100 along the cross-sectional line 315 of FIG. 3. Specifically, FIG. 4 shows a cross-section of the connector 100, in an assembled state, at its projecting part 113a. Thus, a section of the O-ring 109a and a section 400 of the pin 107a are illustrated. The section 400 of the pin 107a is a section in a plane orthogonal to the elongation direction 200 of the pin 107a.

Such as also described in reference to FIG. 2, the narrowed part 203 is machined so as to have a rounded section 400. In particular, FIG. 4 shows that the rounded section 400 is, in the present embodiment, a section being stadium-shaped, i.e. a section 400 having two parallel sides 401a, 401b which connect between them two elliptical arcs 403a, 403b arranged at the opposite ends of the parallel sides 401a, 401b. In this case, the arc 403b corresponds to the edge 231 of FIG. 2. In a variation, the section 400 can also have four two-by-two parallel sides, which connect between them four quarter-circular arcs, arranged at the intersections of the four two-by-two parallel sides.

Thanks to the rounded section 400, the narrowed part 203 is particularly adapted for housing the O-ring 109a. In particular, the section 400 has a shape configured to be fitted by the O-ring 109. In this case, the pin 107a is provided with the O-ring 109a housed in the narrowed part 203, the O-ring 109a fitting the section 400, i.e. the contour, of the narrowed part 203.

In this configuration, the O-ring 109a can seal the insertion of the pin 107a into the opening 303a, without losing sealing performance or durability due to the rectangular section of the first part 201 of the pin 107a. In other words, the radial sealing performance and cost efficiency of the O-ring is adapted for a male electrical connector with pins of rectangular cross-section. Thus, an improved solution is provided for sealing the installation of pins with a rectangular section in an electrical connector housing. As an example, sealing performance up to IP54 can be achieved by means of a conventional O-ring.

The inner surface 307 of the projecting part 113a which produces the open inner space 309 has a shape which is configured to be fitted by the O-ring 109a. In particular, in a plane orthogonal to the insertion direction 300, the open inner space 309 has a section being stadium-shaped corresponding to the shape and thickness 405 of the seal 109a when housed in the narrowed part 203. I.e. the projecting part 113a is moulded to envelop the O-ring 109a such that the O-ring 109a sealingly fits the inner surface 307. Thus, such as illustrated in FIG. 4, the O-ring 109a is housed in the sealing seat 309 of the housing 101, so as to fit the shape of the projection 113a. The sealing performance of the connector 100 is thus improved, and the O-ring 109a is protected from environmental externalities.

In variants of the connector 100, the male electrical connector can comprise only one single electrical contact. Alternatively, the male electrical connector can comprise a plurality, for example 3, 6 or 8, of electrical contacts. In other variants, the electrical connector cannot comprise retaining elements such as the retaining elements 105a, 105b. In other variants, a locking means for the contact pins 107a, 107b different from, or additional to, the present locking tab system 219 can be considered.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical contact for a male electrical connector, the electrical contact comprising:
an O-ring; and
an electrical contact pin holding the O-ring, the electrical contact pin including a first part configured to establish an electrical contact with a homologous electrical terminal, the first part being disposed at a first end of the pin and having, in a plane orthogonal to the elongation direction of the pin, a rectangular section, the electrical contact pin including a second part configured for connecting the pin to an electrical conductor, the second part being disposed at a second end of the pin opposite the first end, wherein, between the first part and the second part, the electrical contact pin includes a narrowed part adapted to house the O-ring,
wherein the O-ring is arranged at the pin, so as to be housed in the narrowed part.

2. Electrical contact according to claim 1, wherein the narrowed part includes, in a plane orthogonal to the elongation direction of the pin, a rounded section having a shape configured to be fitted by an O-ring.

3. Electrical contact according to claim 2, wherein the narrowed part has an oval section or an elliptical section or a section having two parallel sides which connect two arcs arranged at opposite ends of the parallel sides.

4. Electrical contact according to claim 1, further comprising, in a first side of the pin corresponding to a first extension of the rectangular section of the first part, a first indentation, and, in a second side of the pin opposite the first side, a second indentation opposite the first indentation, the first and second indentations together forming the narrowed part.

5. Electrical contact according to claim 4, wherein the first indentation and/or the second indentation have a depth of between 100% and 300% of the first extension of the rectangular section of the first part.

6. Electrical contact according to claim 4, wherein the edges of the first indentation and/or the second indentation are rounded along an oval or elliptical or circular arc.

7. Electrical contact according to claim 4, wherein the first indentation and/or the second indentation have a depth of between 10% and 40% of a second extension orthogonal to the first extension of the rectangular section of the first part.

8. Electrical contact pin for an electrical contact, the electrical contact pin comprising:
a first part configured to establish an electrical contact with a homologous electrical terminal, the first part being disposed at a first end of the pin and having, in a plane orthogonal to the elongation direction of the pin, a rectangular section;
a second part configured to connect the pin to an electrical conductor, the second part being disposed at a second end of the pin opposite the first end; and
between the first part and the second part, a narrowed part adapted to house an O-ring.

9. Electrical contact pin according to claim 8, wherein the narrowed part includes, in a plane orthogonal to the elongation direction of the pin, a rounded section having a shape configured to be fitted by an O-ring.

10. Electrical contact pin according to claim 8, further comprising, in a first side of the pin corresponding to a first extension of the rectangular section of the first part, a first indentation, and, in a second side of the pin opposite the first side, a second indentation opposite the first indentation, the first and second indentations together forming the narrowed part.

11. Connector housing for a male electrical connector, the connector housing comprising:
a cavity configured to house an electrical contact including an O-ring and an electrical contact pin holding the O-ring, the electrical contact pin including a first part configured to establish an electrical contact with a homologous electrical terminal, the first part being disposed at a first end of the pin and having, in a plane orthogonal to the elongation direction of the pin, a rectangular section, the electrical contact pin including a second part configured for connecting the pin to an electrical conductor, the second part being disposed at a second end of the pin opposite the first end, wherein, between the first part and the second part, the electrical contact pin includes a narrowed part adapted to house the O-ring, wherein the O-ring is arranged at the pin, so as to be housed in the narrowed part;
a first face comprising an opening leading to the cavity, the opening having a rectangular section configured to receive the pin; and
a projecting part extending along a perimeter of the opening and having a shape configured to be fitted by an O-ring housed in the narrowed part of the pin, so as to form a sealing seat.

12. Connector housing according to claim 11, wherein the narrowed part includes, in a plane orthogonal to the elongation direction of the pin, a rounded section having a shape configured to be fitted by an O-ring.

13. Connector housing according to claim 11, further comprising, in a first side of the pin corresponding to a first extension of the rectangular section of the first part, a first indentation, and, in a second side of the pin opposite the first side, a second indentation opposite the first indentation, the first and second indentations together forming the narrowed part.

14. Male electrical connector comprising:
a housing including a cavity, a first face comprising an opening leading to the cavity having a rectangular section, and a projecting part extending along a perimeter of the opening and having a shape forming a sealing seat; and
an electrical contact including an O-ring and an electrical contact pin holding the O-ring, the electrical contact pin including a first part configured to establish an electrical contact with a homologous electrical terminal, the first part being disposed at a first end of the pin and having, in a plane orthogonal to the elongation direction of the pin, a rectangular section, the electrical contact pin including a second part configured for connecting the pin to an electrical conductor, the second part being disposed at a second end of the pin opposite the first end, wherein, between the first part and the second part, the electrical contact pin includes a narrowed part adapted to house the O-ring, wherein the O-ring is arranged at the pin, so as to be housed in the narrowed part;
the pin being housed in the cavity such that the second part is arranged inside the housing and the first part is arranged outside the housing, and the O-ring being housed in the sealing seat of the housing, so as to fit the shape of the projecting part extending along the perimeter of the opening.

15. Male electrical connector according to claim 14, wherein the narrowed part includes, in a plane orthogonal to the elongation direction of the pin, a rounded section having a shape configured to be fitted by an O-ring.

16. Male electrical connector according to claim 14, further comprising, in a first side of the pin corresponding to a first extension of the rectangular section of the first part, a first indentation, and, in a second side of the pin opposite the first side, a second indentation opposite the first indentation, the first and second indentations together forming the narrowed part.
